(19) United States
(12) Patent Application Publication
(10) Pub. No.: US 2026/0303146 A1
(43) Pub. Date: Oct. 1, 2026

(54) METHODS AND APPARATUSES FOR POSITIONING FOR UES WITH LIMITED CAPABILITY

(71) Applicant: LENOVO (BEIJING) LIMITED, Beijing (CN)

(72) Inventors: Jie Hu, Beijing (CN); Jing Han, Beijing (CN); Lianhai Wu, Beijing (CN); Ran Yue, Beijing (CN); Haiming Wang, Beijing (CN)

(21) Appl. No.: 19/479,276

(22) PCT Filed: Apr. 28, 2023
(86) PCT No.: PCT/CN2023/091800

§ 371 Date: Oct. 27, 2025

(51) Int. Cl. H04B 1/713; H04L 5/00; H04W 64/00

(52) U.S. Cl. CPC H04B 1/713; H04L 5/0051; H04W 64/00

(57) ABSTRACT

The present application relates to methods and apparatuses for positioning for user equipments (UEs) with a limited capability. One embodiment of the present disclosure provides a UE, comprising: a transceiver; and a processor coupled with the transceiver and configured to: receive, via the transceiver, a sounding reference signal (SRS) frequency hopping (FH) configuration or a positioning reference signal (PRS) FH configuration based on a condition being fulfilled; and perform an SRS transmission based on the SRS FH configuration in the case that the SRS FH configuration is received, or perform a PRS measurement based on the PRS FH configuration in the case that the PRS FH configuration is received.

### TECHNICAL FIELD

The present disclosure relates to wireless communication, and particularly relates to methods and apparatuses for positioning for user equipments (UEs) with a limited capability.

### BACKGROUND OF THE INVENTION

For a UE with a limited capability, or a UE with a reduced capability, which may be referred to as a Redcap UE, it may not be able to operate in a wideband as other UEs. To support positioning for UEs with a limited capability, frequency hopping (FH) may be applied.

Accordingly, solutions for FH configuration and coordination of assistance information related to FH between UEs with a limited capability and a network are needed.

### SUMMARY

One embodiment of the present disclosure provides a UE, comprising: a transceiver; and a processor coupled with the transceiver and configured to: receive, via the transceiver, a sounding reference signal (SRS) FH configuration or a positioning reference signal (PRS) FH configuration based on a condition being fulfilled; and perform an SRS transmission based on the SRS FH configuration in the case that the SRS FH configuration is received, or perform a PRS measurement based on the PRS FH configuration in the case that the PRS FH configuration is received.

In some embodiments, the condition comprises: the UE being identified as a UE with a limited capability, or there being an identified need for the SRS FH configuration or the PRS FH configuration.

In some embodiments, the SRS FH configuration is received from a base station (BS), or the PRS FH configuration is received from a location management function (LMF) entity.

In some embodiments, the SRS FH configuration is received with an SRS configuration, or the PRS FH configuration is received with a PRS configuration.

In some embodiments, the processor is further configured to: transmit, via the transceiver, a request for PRS FH configuration if the UE identifies the need for the PRS FH configuration.

In some embodiments, the UE identifies the need for the PRS FH configuration when an accuracy requirement for positioning is increased to a first threshold, or when a reference signal received power (RSRP) value of a measured PRS is lower than a second threshold during a time duration.

In some embodiments, the SRS FH configuration or the PRS FH configuration is received after an LMF entity identifies the need, wherein the LMF entity identifies the need for the SRS FH configuration or for the PRS FH configuration when an accuracy requirement for positioning is increased to a first threshold, or when a received SRS or PRS measurement result does not satisfy the accuracy requirement.

In some embodiments, the processor is further configured to: receive, via the transceiver, a first indication indicating an activation or deactivation associated with the SRS FH configuration, or a second indication indicating an activation or deactivation associated with the PRS FH configuration.

In some embodiments, the first indication is associated with first time information to activate or deactivate the SRS FH configuration, or the second indication is associated with second time information to activate or deactivate the PRS FH configuration.

In some embodiments, the processor is further configured to: transmit, via the transceiver, a request for activating or deactivating the SRS FH configuration or for activating or deactivating the PRS FH configuration.

In some embodiments, the processor is further configured to: transmit, via the transceiver and to a BS, a request for a measurement gap for performing location measurements and the received PRS FH configuration.

In some embodiments, the processor is further configured to: receive, via the transceiver, an SRS configuration associated with a wideband; and determine information associated with a transmission hop within the wideband.

In some embodiments, the SRS configuration indicates a maximum hopping bandwidth, or a total number of hops in the wideband.

In some embodiments, the processor is further configured to: receive, via the transceiver, an SRS configuration associated with one or more bandwidth parts; and perform the SRS transmission in an activated bandwidth part of the one or more bandwidth parts.

In some embodiments, the processor is further configured to: transmit, via the transceiver, capability information of the UE.

Another embodiment of the present disclosure provides a BS, comprising: a transceiver; and a processor coupled with the transceiver and configured to: receive, via the transceiver, capability information of a UE; and perform at least one of the following: transmitting, via the transceiver, an SRS FH configuration to the UE based on a first condition being fulfilled; or transmitting, via the transceiver, a PRS FH configuration to an LMF entity or receiving, via the transceiver, a determined PRS FH configuration from the LMF entity based on a second condition being fulfilled.

In some embodiments, the first condition comprises: the UE being identified as a UE with a limited capability, or there being an identified need for the SRS FH configuration; and wherein the second condition comprises: the UE being identified as a UE with a limited capability, or there being an identified need for the PRS FH configuration.

In some embodiments, the processor is further configured to: receive, via the transceiver and from the LMF entity, a request for the PRS FH configuration or the SRS FH configuration.

In some embodiments, the request indicates a type of the PRS FH configuration or the SRS FH configuration.

In some embodiments, the processor is further configured to: transmit, via the transceiver, the capability information of the UE to the LMF entity.

In some embodiments, in the case that the SRS FH configuration is determined by the BS, the processor is further configured to: transmit, via the transceiver, the SRS FH configuration to the LMF entity.

In some embodiments, in the case that the SRS FH configuration is determined by the LMF entity, the processor is further configured to: receive, via the transceiver, the SRS FH configuration from the LMF entity.

In some embodiments, the processor is further configured to: receive, via the transceiver and from the LMF entity, a first indication indicating an activation or deactivation associated with the SRS FH configuration; and transmit, via the transceiver, the first indication to the UE.

In some embodiments, the first indication is associated with first time information to activate or deactivate the SRS FH configuration.

In some embodiments, the processor is further configured to: transmit, via the transceiver and to a neighbor BS, a first indication indicating an activation or deactivation associated with the SRS FH configuration, or a second indication indicating an activation or deactivation associated with the PRS FH configuration.

In some embodiments, the first indication is associated with first time information to activate or deactivate the SRS FH configuration, or the second indication is associated with second time information to activate or deactivate the PRS FH configuration.

In some embodiments, the processor is further configured to: receive, via the transceiver and from the UE, a request for activating or deactivating the SRS FH configuration or for activating or deactivating the PRS FH configuration.

In some embodiments, the processor is further configured to perform at least one of the following: transmitting, via the transceiver and to the UE, a configuration of a measurement gap or a PRS processing window (PPW) for performing location measurements which is determined based at least in part on the PRS FH configuration received from the LMF entity; or transmitting, via the transceiver and to the LMF entity, the configuration of the measurement gap or the PPW for performing location measurements.

In some embodiments, the processor is further configured to: receive, via the transceiver and from the UE, a request for a measurement gap for performing location measurements and a PRS FH configuration.

In some embodiments, the processor is further configured to: transmit, via the transceiver and to the UE, an SRS configuration associated with a wideband or one or more bandwidth parts.

In some embodiments, the SRS configuration associated with the wideband indicates a maximum hopping bandwidth, or a total number of hops in the wideband.

Yet another embodiment of the present disclosure provides an LMF entity, comprising: a transceiver; and a processor coupled with the transceiver and configured to: receive, via the transceiver, capability information of a UE; and perform at least one of the following: transmitting, via the transceiver, a determined SRS FH configuration to a serving BS of the UE or receiving, via the transceiver, an SRS FH configuration from the serving BS based on a first condition being fulfilled; or transmitting, via the transceiver, a determined PRS FH configuration to the UE based on a second condition being fulfilled.

In some embodiments, the first condition comprises: the UE being identified as a UE with a limited capability, or there being an identified need for the SRS FH configuration; and wherein the second condition comprises: the UE being identified as a UE with a limited capability, or there being an identified need for the PRS FH configuration.

In some embodiments, the PRS FH configuration is determined by the LMF entity based on one or more PRS configurations or one or more PRS FH configurations received from one or more BSs; or the transmitted SRS FH configuration is determined by the LMF entity based on one or more SRS configurations or one or more SRS FH configurations received from one or more BSs.

In some embodiments, the capability information of the UE is received from the serving BS or from the UE.

In some embodiments, the PRS FH configuration is determined by the serving BS, and the processor is further configured to: receive, via the transceiver, the PRS FH configuration from the serving BS.

In some embodiments, the PRS FH configuration is determined by the LMF entity and is transmitted to the UE in updated assistance data in the case that the LMF entity identifies the need for the PRS FH configuration, wherein the LMF entity identifies the need for the PRS FH configuration when an accuracy requirement for positioning is increased to a first threshold, or when a received PRS measurement result does not satisfy the accuracy requirement.

In some embodiments, the processor is further configured to: receive, via the transceiver and from the UE, a request for PRS FH configuration.

In some embodiments, in the case that the LMF entity identifies the need for the SRS FH configuration, the processor is further configured to: determine the transmitted SRS FH configuration; or transmit, via the transceiver, a request for SRS FH configuration to the serving BS, wherein the LMF entity identifies the need for the SRS FH configuration when an accuracy requirement for positioning is increased to a first threshold, or when a received SRS measurement result does not satisfy the accuracy requirement.

In some embodiments, the processor is further configured to: transmit, via the transceiver and to the serving BS, a request for the PRS FH configuration or the SRS FH configuration.

In some embodiments, the request indicates a type of the PRS FH configuration or the SRS FH configuration.

In some embodiments, the processor is further configured to: transmit, via the transceiver to the serving BS, a first indication indicating an activation or deactivation associated with the SRS FH configuration; or transmit, via the transceiver to the UE, a second indication indicating an activation or deactivation associated with the PRS FH configuration.

In some embodiments, the first indication is associated with first time information to activate or deactivate the SRS FH configuration, or the second indication is associated with second time information to activate or deactivate the PRS FH configuration.

In some embodiments, the processor is further configured to: transmit, via the transceiver and to a neighbor BS of the serving BS, the first indication or the second indication.

In some embodiments, the processor is further configured to: receive, via the transceiver and from the serving BS, a configuration of a measurement gap or a PPW for performing location measurements; and determine the PRS FH configuration based at least in part on the configuration of the measurement gap or the PPW.

In some embodiments, the processor is further configured to: transmit, via the transceiver and to the BS, the determined PRS FH configuration.

Yet another embodiment of the present disclosure provides a method performed by a UE, comprising: receiving an SRS FH configuration or a PRS FH configuration based on a condition being fulfilled; and performing an SRS transmission based on the SRS FH configuration in the case that the SRS FH configuration is received, or performing a PRS measurement based on the PRS FH configuration in the case that the PRS FH configuration is received.

Yet another embodiment of the present disclosure provides a method performed by a BS, comprising: receiving capability information of a UE; and performing at least one of the following: transmitting an SRS FH configuration to the UE based on a first condition being fulfilled; or transmitting a PRS FH configuration to an LMF entity or receiving a determined PRS FH configuration from the LMF entity based on a second condition being fulfilled.

Yet another embodiment of the present disclosure provides a method performed by an LMF entity, comprising: receiving capability information of a UE; and performing at least one of the following: transmitting a determined SRS FH configuration to a serving BS of the UE or receiving an SRS FH configuration from the serving BS based on a first condition being fulfilled; or transmitting a determined PRS FH configuration to the UE based on a second condition being fulfilled.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure.

FIGS. 2A and 2B illustrate different types of downlink (DL) PRS frequency hopping according to some embodiments of the present disclosure.

FIGS. 3A and 3B illustrate different types of uplink (UL) SRS frequency hopping according to some embodiments of the present disclosure.

FIG. 4 illustrates a method performed by a UE for positioning according to some embodiments of the present disclosure.

FIG. 5 illustrates a method performed by a BS for positioning for a UE with a limited capability according to some embodiments of the present disclosure.

FIG. 6 illustrates a method performed by an LMF entity for positioning for a UE with a limited capability according to some embodiments of the present disclosure.

FIG. 7 illustrates a simplified block diagram of an apparatus according to some embodiments of the present disclosure.

### DETAILED DESCRIPTION

The detailed description of the appended drawings is intended as a description of the currently preferred embodiments of the present disclosure, and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA) based network, a code division multiple access (CDMA) based network, an orthogonal frequency division multiple access (OFDMA) based network, a long term evolution (LTE) network, a 3^{rd} generation partnership project (3GPP) based network, LTE-Advanced (LTE-A), 3GPP 4G, 3GPP 5G new radio (NR), 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates an exemplary wireless communication system 100 according to some embodiments of the present disclosure.

As shown in FIG. 1, the wireless communication system 100 includes at least one BS 101, at least one UE (e.g., a UE 102a and a UE 102b), and at least one LMF 103. Although one BS, two UEs, and one LMF are depicted in FIG. 1 for illustrative purpose, it is contemplated that any number of BSs, UEs, and LMFs may be included in the wireless communication system 100.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b shown in FIG. 1 are in a coverage area of the BS 101, and may transmit information or data to the BS 101 and receive control information or data from the BS 101, for example, via LTE or NR Uu interface.

The BS 101 as illustrated and shown in FIG. 1 may not be a specific base station, but may be any base station(s) in the wireless communication system 100. For example, if the wireless communication system 100 includes two BSs 102, the UE 102a being within a coverage area of any one the two BSs 102 may be considered that the UE 102a is within a coverage of BS 101 in the wireless communication system 100; and only the UE 102a being outside of coverage area(s) of both BSs 101 can be called as a case that the UE 102a is outside of the coverage of BS 101 in the wireless communication system 100.

The BS 101 may be distributed over a geographic region. In certain embodiments, the BS 101 may also be referred to as an access point, an access terminal, a base, a macro cell, a Node-B, an enhanced Node B (eNB), a next generation node B (gNB), a home Node-B, a relay node, or a device, or described using other terminology used in the art. The BS 101 is generally part of a radio access network (RAN) that may include one or more controllers communicably coupled to one or more corresponding BSs 101.

The wireless communication system 100 is compatible with any type of network that is capable of sending and receiving wireless communication signals. For example, the wireless communication system 100 is compatible with a wireless communication network, a cellular telephone network, a TDMA-based network, a CDMA-based network, an OFDMA-based network, an LTE network, a 3GPP-based network, a 3GPP 5G network, a satellite communications network, a high-altitude platform network, and/or other communications networks.

In one embodiment, the wireless communication system 100 is compatible with the 5G NR of the 3GPP protocol, wherein the BS 101 may transmit data to the UE 102a or 102b using an orthogonal frequency division multiplexing (OFDM) modulation scheme on the DL, and the UE 102a or 102b may transmit data to the BS 101 on the UL using a single-carrier frequency division multiple access (SC-FDMA) or OFDM scheme. More generally, however, the wireless communication system 100 may implement some other open or proprietary communication protocols, for example, WiMAX, among other protocols.

In other embodiments, the BS 101 may communicate using other communication protocols, such as the IEEE 802.11 family of wireless communication protocols. Further, in some embodiments, the BS 101 may communicate over licensed spectrums, whereas in other embodiments the BS 101 may communicate over unlicensed spectrums. The present disclosure is not intended to be limited to the implementation of any particular wireless communication system architecture or protocol. In another embodiment, the BS 101 may communicate with the UE 102a or 102b using the 3GPPP 5G protocols.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102a or UE 102b via LTE positioning protocol (LPP) signaling.

In some embodiments, the UE 102a or 102b may be a UE with a normal capability, e.g., a legacy enhanced mobile broadband (eMBB) or ultra-reliable and low latency communications (URLLC) UE. In some embodiments, the UE 102a or 102b may be a UE with a limited capability, e.g., a RedCap UE.

For a UE with a limited capability, it may not be able to operate in a wideband, but may operate in narrower bandwidths. For positioning for UEs with a limited capability, frequency hopping may be used. The benefits and performance gains of frequency hopping for DL PRS or UL SRS are investigated, considering at least the following:
Impact of Doppler, phase offset, timing offset, power imbalance among hops;
UE capability and complexity considerations;
Impact of radio frequency (RF) retuning during frequency hopping; and
Details of frequency hopping (including transmission hopping and/or reception hopping, bandwidth part (BWP) switching).

From a UE with a limited capability's perspective, the frequency hopping may be supported for both the DL PRS reception and the UL SRS transmission. There may be different types for both DL PRS frequency hopping and UL SRS frequency hopping.

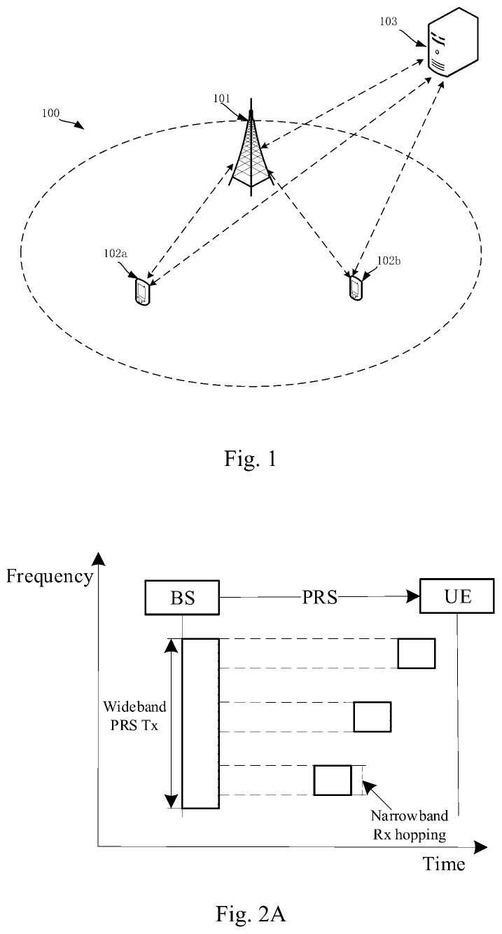

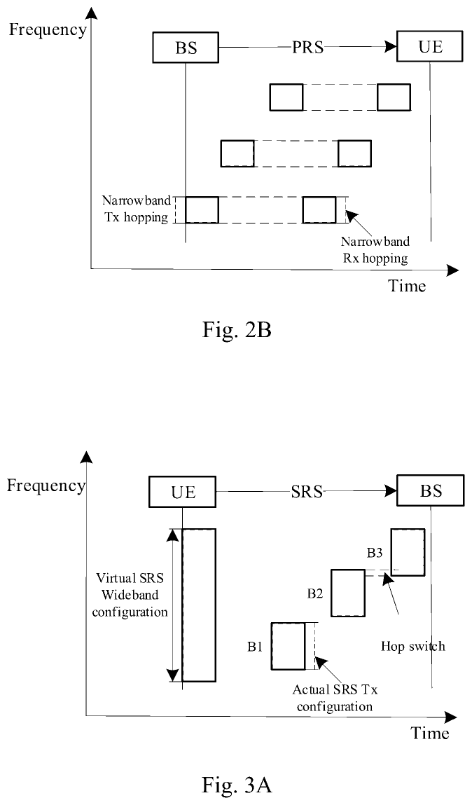

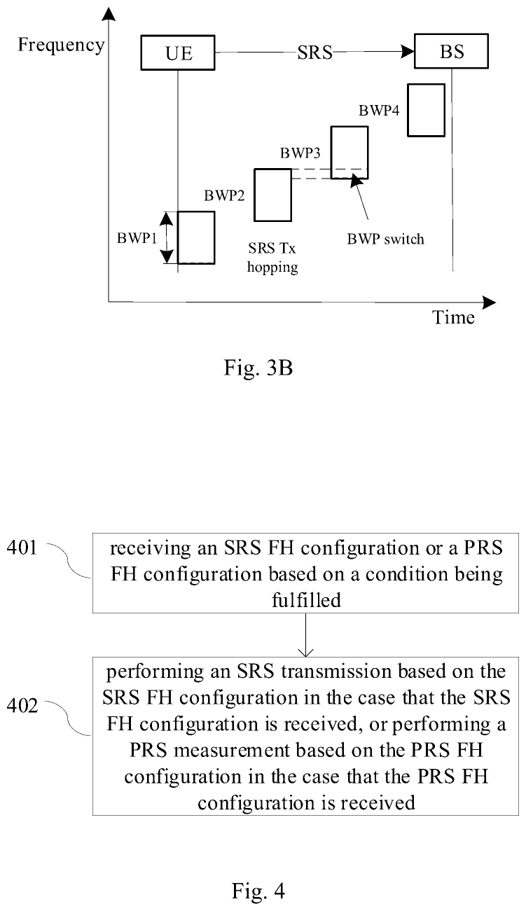

FIGS. 2A and 2B illustrates different types of DL PRS frequency hopping according to some embodiments of the present disclosure. FIGS. 3A and 3B illustrate different types of UL SRS frequency hopping according to some embodiments of the present disclosure.

In each of FIGS. 2A-3B, there are two entities, i.e., a BS and a UE. The BS may be the BS 101 as shown in FIG. 1. In some embodiments, the BS may be a transmit-receive point (TRP). The UE may be the UE 102a or 102b as shown in FIG. 1, and may be a UE with a limited capability.

FIG. 2A depicts a type of DL PRS frequency hopping (FH), which may be referred to as Type 1 PRS FH. The BS (or the TRP) may perform DL PRS transmission in a wideband (marked as “wideband PRS Tx”). The UE may be configured with a frequency hopping configuration to perform DL PRS reception. For example, the UE may perform frequency hopping in three narrowbands as shown in FIG. 2A. In other words, the UE may perform narrowband reception hopping (marked as “Narrowband Rx hopping”) for DL PRS.

FIG. 2B depicts another type of DL PRS FH, which may be referred to as Type 2 PRS FH. In the example shown in FIG. 2B, three narrowbands are configured for the BS and the UE to perform frequency hopping. The BS (or the TRP) may perform DL PRS transmission in the three narrowbands. In other words, the BS (or the TRP) may perform narrowband transmission hopping (marked as “Narrowband Tx hopping”). The UE may correspondingly perform DL PRS reception in the three narrowbands. In other words, the UE may perform narrowband reception hopping (marked as “Narrowband Rx hopping”) among the narrowbands.

FIG. 3A depicts a type of UL SRS FH, which may be referred to as Type 1 SRS FH. The UE may be configured with a virtual SRS wideband configuration. However, the UE may not be able to perform UL SRS transmission in the wideband. Based on the virtual SRS wideband configuration, the UE may actually perform UL SRS transmission in some determined narrowbands according to the actual SRS transmission configuration (marked as “Actual SRS Tx configuration”). For example, three narrowbands (e.g., B1, B2, and B3) may be determined. In other words, the UE may perform narrow band transmission hopping for UL SRS. In some scenarios, the narrowbands may overlap in the frequency domain. In some other scenarios, the narrowbands may non-overlap in the frequency domain. The UE may perform hop switch during any time of the hopping duration. For example, the UE may perform hop switch in the overlapped part of B2 and B3 (marked as “Hop switch”).

FIG. 3B depicts another type of UL SRS FH, which may be referred to as Type 2 SRS FH. The UE may be configured with multiple BWPs, for example, BWP1, BWP2, BWP3, and BWP4. The UE may perform UL SRS transmission in these BWPs, for example, in an activated BWP among these BWPs. In some scenarios, the BWPs may overlap in the frequency domain. In some other scenarios, the BWPs may non-overlap in the frequency domain. The UE may perform BWP switch during any time of the BWP transmission. For example, the UE may perform BWP switch in the overlapped part of BWP2 and BWP3 (marked as “BWP switch”).

In order to perform positioning for UEs with a limited capability with the above different types of frequency hopping design for both PRS and SRS, the present disclosure proposes some solutions as follows:

### Solution 1

In this solution, an LMF entity or a serving BS of a UE may determine an SRS FH configuration, or a PRS FH configuration, or both the SRS FH configuration and the PRS FH configuration when one of the following conditions is fulfilled:
1. the UE is identified as a UE with a limited capability, such as a RedCap UE; or
2. there is an identified need for FH configuration, which may include the need for SRS FH configuration, the need for PRS FH configuration, or the need for both the SRS FH configuration and the PRS FH configuration.

The LMF entity or the serving BS may identify the UE as a UE with a limited capability based on capability information of the UE. For example, the LMF entity may receive the capability information of the UE from the UE by LPP capability information reporting or from the serving BS by NRPPa assistance information transmission, and the serving BS may receive the capability information of the UE from the UE by capability information reporting via an RRC signalling.

The need for the FH configuration may be identified by the LMF entity. For instance, when a positioning service requirement has changed to a higher-level accuracy requirement (e.g., an accuracy requirement for positioning is increased to a threshold), or when a received SRS or PRS measurement result does not satisfy the accuracy requirement for positioning, the LMF entity may identify a need for the FH configuration.

The need for the FH configuration may be identified by the UE. For example, the UE may identify the need for the FH configuration in one of the following occasions:
1. when a positioning service requirement has changed to a higher-level accuracy requirement, for example, an accuracy requirement for positioning is increased to a threshold; or
2. when an RSRP value of a measured PRS is lower than a pre-defined threshold during a time duration.

Solution 1 may be further classified into the following sub-solutions.

### Sub-Solution 1-1

In sub-solution 1-1, the serving BS of the UE may determine the FH configuration, which may include the SRS FH configuration, the PRS FH configuration, or both, when the serving BS identifies that the UE is a UE with a limited capability.

For PRS FH, the serving BS may transmit the determined PRS FH configuration to the LMF entity. In some embodiments, the determined PRS FH configuration may be transmitted to the LMF entity with TRP assistance data information. In some other embodiments, the determined PRS FH configuration may be the transmitted to the LMF entity with other information or transmitted separately.

After receiving the PRS FH configuration, the LMF entity may transmit the PRS FH configuration to the UE by assistance data. In some embodiments, the LMF entity may transmit the PRS FH configuration with a PRS configuration to the UE.

In some other embodiments, the serving BS may transmit the determined PRS FH configuration to the UE.

For SRS FH, the serving BS may transmit the determined SRS FH configuration to the UE. In some embodiments, the determined SRS FH configuration may be transmitted to the UE with an SRS configuration. In some other embodiments, the determined SRS FH configuration may be transmitted with other information or transmitted separately.

The serving BS may also transmit the determined SRS FH configuration to the LMF entity. In some embodiments, the determined SRS FH configuration may be transmitted to the LMF entity with the SRS configuration for the UE.

In some embodiments, the LMF entity may request the serving BS to provide a specific type of FH configuration, for example, configuration for Type 1 SRS FH, configuration for Type 2 SRS FH, configuration for Type 1 PRS FH, or configuration for Type 2 PRS FH. In some embodiments, the LMF entity may request for the specific type of FH configuration according to capability information of the UE.

In some embodiments, the BS may transmit the capability information of the UE to the LMF entity, which may indicate a maximum sub-bandwidth, a FH bandwidth, etc. The BS may transmit the capability information of the UE to the LMF entity in response to a request from the LMF entity, or voluntarily.

In some embodiments, the UE may report the capability information of the UE to the LMF entity. For example, the UE may transmit the capability information of the UE in a message, e.g., an LPP provide capability message, to the LMF entity, which may indicate a maximum sub-bandwidth, a FH bandwidth, etc. In some scenarios, the message may also indicate that the UE is able to perform Type 1 PRS FH, Type 2 PRS FH, Type 1 SRS FH, Type 2 SRS FH, or any combination thereof.

### Sub-Solution 1-2

In sub-solution 1-2, the LMF entity may determine the FH configuration, which may include the SRS FH configuration, the PRS FH configuration, or both, when the LMF entity identifies that the UE is a UE with a limited capability.

For PRS FH, the LMF entity may determine the PRS FH configuration based on at least one of the following:
1. PRS configuration(s) received from one or more BSs (including the serving BS and/or one or more neighbor BSs), or one or more TRPs; or
2. PRS FH configuration(s) received from one or more BSs (including the serving BS and/or one or more neighbor BSs), or one or more TRPs.

The LMF entity may transmit the determined PRS FH configuration to the UE by an LPP signalling. For example, the LMF entity may provide assistance information to the UE, which may include the PRS FH configuration.

For SRS FH, the LMF entity may determine the SRS FH configuration based on at least one of the following:
1. SRS configuration(s) received from one or more BSs (including the serving BS and/or one or more neighbor BSs), or one or more TRPs; or
2. SRS FH configuration(s) received from one or more BSs (including the serving BS and/or one or more neighbor BSs), or one or more TRPs.

The LMF entity may transmit the determined SRS FH configuration to the serving BS. Then, the serving BS may transmit the received SRS FH configuration to the UE. In some embodiments, the LMF entity may also transmit the determined SRS FH configuration to one or more neighbor BSs. In some other embodiments, the serving BS may transmit the received SRS FH configuration to one or more neighbor BSs. In some other embodiments, the LMF entity may transmit the determined SRS FH configuration to the UE.

In some embodiments, the UE may apply the PRS FH configuration or SRS FH configuration received according to sub-solution 1-1 or 1-2 once the UE receives it. In some other embodiments, the UE apply the PRS FH configuration or SRS FH configuration received according to sub-solution 1-1 or 1-2 when the PRS FH configuration or SRS FH configuration is activated, which will be described later.

### Sub-Solution 1-3

In sub-solution 1-3, the FH configuration, which may include the SRS FH configuration, the PRS FH configuration, or both, may be determined when the LMF entity identifies a need for the FH configuration.

For PRS FH, the LMF entity may determine the PRS FH configuration when the LMF entity identifies a need for the PRS FH configuration, and transmit the determined PRS FH configuration to the UE. For example, the LMF entity may provide updated assistance data to the UE, which may include the determined PRS FH configuration.

For SRS FH, the LMF entity may request the serving BS of the UE to determine the SRS FH configuration. Then, the serving BS may transmit the determined SRS FH configuration to the UE. The serving BS may also transmit the determined SRS FH configuration to the LMF entity. In some embodiments, the serving BS may transmit the determined SRS FH configuration to one or more neighbor BSs.

Alternatively, the LMF entity may determine the SRS FH configuration based on SRS configuration(s) received from one or more BSs (including the serving BS and/or one or more neighbor BSs), or one or more TRPs. Then, the LMF entity may transmit the determined SRS FH configuration to the serving BS, and the serving BS may transmit the received SRS FH configuration to the UE. In some embodiments, the LMF entity may also transmit the determined SRS FH configuration to one or more neighbor BSs. In some other embodiments, the serving BS may transmit the received SRS FH configuration to one or more neighbor BSs. In some other embodiments, the LMF entity may transmit the determined SRS FH configuration to the UE.

The UE may apply the PRS FH configuration or SRS FH configuration received according to sub-solution 1-3 once the UE receives it.

### Sub-Solution 1-4

In sub-solution 1-4, the FH configuration, which may include the SRS FH configuration, the PRS FH configuration, or both, may be determined when the UE identifies a need for the FH configuration.

For example, when the UE identifies the need for the PRS FH configuration, the UE may transmit a request for the PRS FH configuration to the LMF entity. In some embodiments, the UE may transmit an explicit PRS FH configuration request to the LMF entity by an on-demand PRS procedure. In some embodiments, the UE may send a request message, e.g., an LPP request assistance data message for on-demand PRS FH, in a mobile originating location request (MO-LR) location service request message, which may include an updated location service requirement.

Upon the request for the PRS FH configuration, the LMF entity may determine the PRS FH configuration and transmit it to the UE.

In some other embodiments, based on the identified need, the UE may transmit a request, for example, an explicit SRS FH configuration request, to the serving BS. In still some other embodiments, based on the identified need, the UE may transmit a request for both the SRS FH configuration and the PRS FH configuration to the serving BS or to the LMF entity.

The UE may apply the PRS FH configuration or SRS FH configuration received according to sub-solution 1-4 once the UE receives it.

### Sub-Solution 1-5

In sub-solution 1-5, the UE may apply the PRS FH configuration or SRS FH configuration when the PRS FH configuration or SRS FH configuration is activated.

For example, the UE with a limited capability may be configured with both an SRS configuration and an SRS FH configuration simultaneously, or both a PRS configuration and a PRS FH configuration simultaneously, e.g., by applying sub-solution 1-1 or 1-2 or other methods. The SRS FH configuration or the PRS FH configuration may be activated or deactivated by an indication from the LMF entity or the serving BS. For example, the indication may be a first indication that indicates activation of the SRS FH configuration, or deactivation of the SRS FH configuration; or the indication may be a second indication that indicates activation of the PRS FH configuration, or deactivation of the PRS FH configuration; or the indication may be a third indication that indicates activation of both the SRS FH configuration and the PRS FH configuration, or deactivation of both the SRS FH configuration and the PRS FH configuration. The first indication, the second indication, or the third indication may further include time information for the activation or deactivation. For example, the time information may include specific time value(s), time stamp(s), time duration(s), or the like, in which the PRS FH configuration or the SRS FH configuration is activated or deactivated.

For PRS FH, the LMF entity may transmit the second indication indicating activation or deactivation of the PRS FH configuration to the UE by a message, such as the LPP provide assistance data message.

For SRS FH, the LMF entity may transmit the first indication indicating activation or deactivation of the SRS FH configuration to the serving BS of the UE, and the serving BS may transmit a message including the first indication to the UE. In some embodiments, the LMF entity may transmit the first indication (e.g., in an FH activation or deactivation command) to one or more neighbor BSs. In some other embodiments, the serving BS may transmit the first indication (e.g., in an FH activation or deactivation command) to one or more neighbor BSs.

In some embodiments, the UE may transmit a message for requesting the activation or deactivation of the SRS FH configuration or PRS FH configuration. The message may be transmitted to the serving BS, and the serving BS may forward the request to the LMF entity. When the UE receives a message indicating the confirmation of the activation or deactivation of the SRS FH configuration or PRS FH configuration from the LMF entity, the SRS FH configuration or PRS FH configuration is activated or deactivated accordingly. The confirmation can be considered as the indication as described above.

In some embodiments, the message for requesting the activation or deactivation of the SRS FH configuration or PRS FH configuration may also indicate the time information for the activation or deactivation. The time information may include specific time value(s), time stamp(s), time duration(s), or the like, in which the PRS FH configuration or the SRS FH configuration is activated or deactivated.

The LMF entity may transmit a message to one or more neighbor BSs, which may be an FH activation or deactivation command, to inform the one or more neighbor BSs of the activation or deactivation of the SRS FH configuration or PRS FH configuration. The message may also include the time information for the activation or deactivation. Alternatively, the serving BS may transmit a message to one or more neighbor BSs, which may be an FH activation or deactivation command, to inform the one or more neighbor BSs of the activation or deactivation of the SRS FH configuration or PRS FH configuration. The message may also include the time information for the activation or deactivation.

### Solution 2

Solution 2 relates to the alignment between a measurement gap or PPW for performing location measurements and the PRS FH configuration for the UE with a limited capability. In solution 2, the LMF entity may determine the PRS FH configuration.

For a UE with a limited capability, it may be configured with a PRS FH configuration, and it may only perform the PRS measurement in the configured narrowband according to a frequency hopping pattern indicated by the PRS FH configuration. The measurement gap procedure is pre-configured by the network to provide a measurement gap for NR DL-PRS measurements. The BS may activate or deactivate the pre-configured measurement gap upon receiving the request from a UE or from the LMF entity. The PPW procedure is pre-configured by the network to provide a PPW for NR DL-PRS measurements to the UE without measurement gap. The BS may activate the pre-configured PRS processing window upon receiving the request from the LMF entity, and the UE may only perform the PRS measurement in the configured time duration of measurement gap or PPW. Accordingly, the measurement gap or the PPW may need to be aligned with the PRS FH configuration, such that the transmission hop may be within the positioning measurement time window of the UE with a limited capability.

Solution 2 may be further classified into the following sub-solutions.

### Sub-Solution 2-1

In sub-solution 2-1, the LMF entity may determine the PRS FH configuration, and may transmit the determined PRS FH configuration to the serving BS. The determined PRS FH configuration may be transmitted in an NRPPa signaling. The serving BS may determine the measurement gap or the PPW by taking the received PRS FH configuration into consideration, such that the measurement gap or the PPW may be aligned with the PRS FH configuration. Then, the serving BS may transmit a configuration of the measurement gap or the PPW to the UE, e.g., in a radio resource control (RRC) signaling.

### Sub-Solution 2-2

In sub-solution 2-2, in addition to transmitting the configuration of the measurement gap or the PPW to the UE (e.g., in an RRC signaling), the serving BS may also transmit the configuration of the measurement gap or the PPW to the LMF entity. The configuration may be transmitted by an NRPPa signaling. The LMF entity may determine the PRS FH configuration by taking the configuration of the measurement gap or the PPW into consideration, such that the measurement gap or the PPW may be aligned with the PRS FH configuration. Then, the LMF may transmit the determined PRS FH configuration to the UE.

### Sub-Solution 2-3

In sub-solution 2-3, the UE which is configured with the PRS FH configuration determined by the LMF entity may transmit a request for the configuration of the measurement gap for performing the location measurements to the serving BS. Along with the request, the UE may also transmit the PRS FH configuration determined by the LMF entity to the serving BS.

After receiving the request, the serving BS is aware of the PRS FH configuration configured for the UE, and may determine the measurement gap or the PPW by taking the PRS FH configuration into consideration, and transmit the configuration of the measurement gap or the PPW to the UE.

### Solution 3

Solution 3 relates to the performance of the UE based on different types of SRS FH configurations. More specifically, solution 3 relates to the hop switch (as shown in FIG. 3A) and BWP switch (as shown in FIG. 3B) between adjacent hops for a UE with a limited capability.

For Type 1 SRS FH as shown in FIG. 3A, a virtual wideband SRS configuration is configured for the UE with a limited capability, and the UE may perform actual SRS transmission hop by hop. For Type 2 SRS FH as shown in FIG. 3B, the UE may be configured with narrowband SRS configuration and may perform narrow band SRS transmission. With the support of frequency hopping for UL SPS, the UE may need to retune between different hops, and in the case that inter-BWP hopping is configured, the UE may need to perform BWP switch.

Solution 3 may be further classified into the following sub-solutions.

### Sub-Solution 3-1

In sub-solution 3-1, the UE with a limited capability may be configured with a wideband SRS configuration, and may perform actual SRS transmission hop by hop, e.g., as shown in FIG. 3A. The UE may perform SRS transmission within the wideband and each SRS transmission hop may be restricted to a narrowband.

The network (e.g. the serving BS) may transmit a virtual wideband SRS configuration (i.e., an SRS configuration associated with a wideband) to the UE, and the UE may determine the information associated with the transmission hop within the wideband by itself. For example, the UE may determine the information of the transmission hop by UE implementation. The information associated with the transmission hop may include: a hopping pattern, a hopping bandwidth, a hopping duration, or the like.

In some embodiments, the serving BS may further transmit the information associated with the frequency hopping (for example, the maximum hopping bandwidth, the number of hops, or the like) to the UE with the SRS configuration, and the UE may determine each hop based on the received configuration and information.

### Sub-Solution 3-2

In sub-solution 3-2, the UE may be configured with multiple frequency bands, such as multiple BWPs, and only one BWP is activated at the same time. The UE may perform SRS transmission within the activated BWP, e.g., as shown in FIG. 3B.

The network (e.g. the serving BS) may indicate multiple BWP configurations to the UE, which may include a bandwidth, a time duration or the like for each BWP.

The UE may use a specific BWP for SRS transmission according to the time duration of each BWP. For example, the UE may use an activated BWP for SRS transmission. The network may activate or deactivate a specific BWP at any BWP transmission time.

FIG. 4 illustrates a method performed by a UE for positioning according to some embodiments of the present disclosure. It is contemplated that the method also can be performed by any device with similar functions.

In operation 401, the UE may receive an SRS FH configuration or a PRS FH configuration based on a condition being fulfilled. In operation 402, the UE may perform an SRS transmission based on the SRS FH configuration in the case that the SRS FH configuration is received, or perform a PRS measurement based on the PRS FH configuration in the case that the PRS FH configuration is received.

In some embodiments, the condition involved in operation 401 may comprise: the UE being identified as a UE with a limited capability (e.g., as described in sub-solution 1-1 or 1-2), or there being an identified need for the SRS FH configuration or the PRS FH configuration (e.g., as described in sub-solution 1-3 or 1-4). The need may be identified by the UE (e.g., as described in sub-solution 1-4) or the LMF entity (e.g., as described in sub-solution 1-3).

In some embodiments, the UE may receive the SRS FH configuration from a BS, or receive the PRS FH configuration from an LMF entity.

In some embodiments, the SRS FH configuration is received with an SRS configuration, or the PRS FH configuration is received with a PRS configuration.

In some embodiments, the UE may further transmit a request for PRS FH configuration if the UE identifies the need for the PRS FH configuration (e.g., as described in sub-solution 1-4). For example, the UE may identify the need for the PRS FH configuration when an accuracy requirement for positioning is increased to a first threshold, or when a RSRP value of a measured PRS is lower than a second threshold during a time duration.

In some embodiments, the SRS FH configuration or the PRS FH configuration is received after an LMF entity identifies the need (e.g., as described in sub-solution 1-3), wherein the LMF entity may identify the need for the SRS FH configuration or for the PRS FH configuration when an accuracy requirement for positioning is increased to a first threshold, or when a received SRS or PRS measurement result does not satisfy the accuracy requirement.

In some embodiments, the UE may receive a first indication indicating an activation or deactivation associated with the SRS FH configuration, or a second indication indicating an activation or deactivation associated with the PRS FH configuration (e.g., as described in sub-solution 1-5). The first indication and the second indication may be different, or may be the same indication.

In some embodiments, the first indication is associated with first time information to activate or deactivate the SRS FH configuration, or the second indication is associated with second time information to activate or deactivate the PRS FH configuration. The first time information and the second time information may be different, or may be the same time information.

In some embodiments, the UE may further transmit a request for activating or deactivating the SRS FH configuration or for activating or deactivating the PRS FH configuration (e.g., as described in sub-solution 1-5).

In some embodiments, the UE may further transmit, to a BS, a request for a measurement gap for performing location measurements and the received PRS FH configuration (e.g., as described in sub-solution 2-3).

In some embodiments, the UE may further receive an SRS configuration associated with a wideband, and determine information associated with a transmission hop within the wideband (e.g., as described in sub-solution 3-1). In some embodiments, the SRS configuration indicates a maximum hopping bandwidth, or a total number of hops in the wideband.

In some embodiments, the UE may further receive an SRS configuration associated with one or more bandwidth parts, and perform the SRS transmission in an activated bandwidth part of the one or more bandwidth parts (e.g., as described in sub-solution 3-2).

In some embodiments, the UE may further transmit capability information of the UE. The capability information may be transmitted to the BS or to the LMF entity.

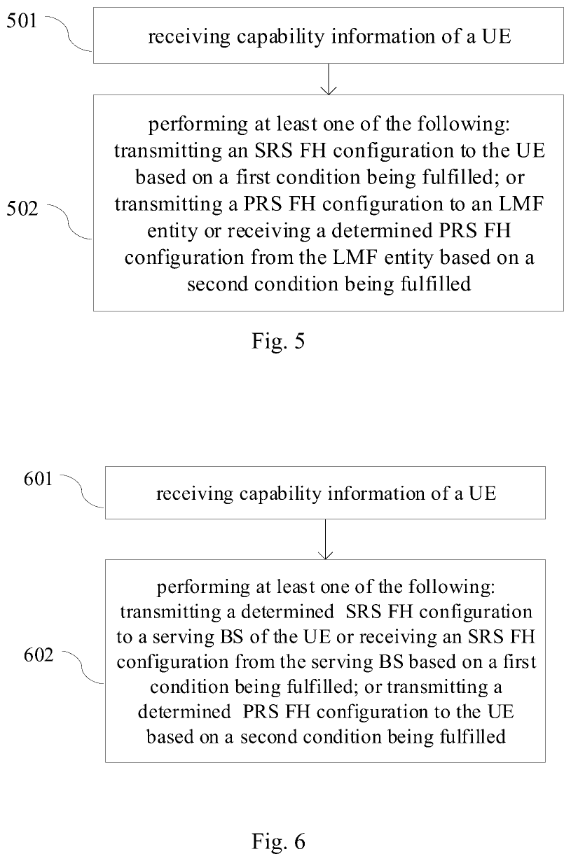

FIG. 5 illustrates a method performed by a BS for positioning for UEs with a limited capability according to some embodiments of the present disclosure. It is contemplated that the method also can be performed by any device with similar functions.

In operation 501, the BS may receive capability information of a UE. In operation 502, the BS may perform at least one of the following: transmitting an SRS FH configuration to the UE based on a first condition being fulfilled; or transmitting a PRS FH configuration to an LMF entity or receiving a determined PRS FH configuration from the LMF entity based on a second condition being fulfilled. The PRS FH configuration transmitted to the LMF entity may be determined by the BS, and the PRS FH configuration received from the LMF entity may be determined by the LMF entity.

In some embodiments, the first condition may comprise: the UE being identified as a UE with a limited capability (e.g., as described in sub-solution 1-1 or 1-2), or there being an identified need for the SRS FH configuration (e.g., as described in sub-solution 1-3 or 1-4); and the second condition may comprise: the UE being identified as a UE with a limited capability (e.g., as described in sub-solution 1-1 or 1-2), or there being an identified need for the PRS FH configuration (e.g., as described in sub-solution 1-3 or 1-4).

In some embodiments, the BS may further receive, from the LMF entity, a request for the PRS FH configuration or the SRS FH configuration (e.g., as described in sub-solution 1-1).

In some embodiments, the request may indicate a type of the PRS FH configuration or the SRS FH configuration, for example, a configuration for any of the two types of PRS FH as shown in FIGS. 2A and 2B or the two types of SRS FH as shown in FIGS. 3A and 3B.

In some embodiments, the BS may further transmit the capability information of the UE to the LMF entity.

In some embodiments, in the case that the SRS FH configuration is determined by the BS, the BS may further transmit the SRS FH configuration to the LMF entity (e.g., as described in sub-solution 1-1).

In some embodiments, in the case that the SRS FH configuration is determined by the LMF entity, the BS may further receive the SRS FH configuration from the LMF entity (e.g., as described in sub-solution 1-2).

In some embodiments, the BS may further receive, from the LMF entity, a first indication indicating an activation or deactivation associated with the SRS FH configuration, and transmit the first indication to the UE (e.g., as described in sub-solution 1-5).

In some embodiments, the first indication is associated with first time information to activate or deactivate the SRS FH configuration.

In some embodiments, the BS may further transmit, to a neighbor BS, a first indication indicating an activation or deactivation associated with the SRS FH configuration, or a second indication indicating an activation or deactivation associated with the PRS FH configuration (e.g., as described in sub-solution 1-5).

In some embodiments, the first indication is associated with first time information to activate or deactivate the SRS FH configuration, or the second indication is associated with second time information to activate or deactivate the PRS FH configuration.

In some embodiments, the BS may further receive, from the UE, a request for activating or deactivating the SRS FH configuration or for activating or deactivating the PRS FH configuration (e.g., as described in sub-solution 1-5).

In some embodiments, the BS may further perform at least one of the following: transmitting, to the UE, a configuration of a measurement gap or a PPW for performing location measurements which is determined based at least in part on the PRS FH configuration received from the LMF entity (e.g., as described in sub-solution 2-1); or transmitting, to the LMF entity, the configuration of the measurement gap or the PPW for performing location measurements (e.g., as described in sub-solution 2-2). The LMF entity may determine the PRS FH configuration based on the configuration of the measurement gap or the PPW received from the BS (e.g., as described in sub-solution 2-2).

In some embodiments, the BS may further receive, from the UE, a request for a measurement gap for performing location measurements and a PRS FH configuration (e.g., as described in sub-solution 2-3).

In some embodiments, the BS may further transmit, to the UE, an SRS configuration associated with a wideband (e.g., as described in sub-solution 3-1) or one or more bandwidth parts (e.g., as described in sub-solution 3-2).

In some embodiments, the SRS configuration associated with the wideband indicates a maximum hopping bandwidth, or a total number of hops in the wideband.

FIG. 6 illustrates a method performed by an LMF entity for positioning for a UE with a limited capability according to some embodiments of the present disclosure. It is contemplated that the method also can be performed by any device with similar functions.

In operation 601, the LMF entity may receive capability information of a UE. In operation 602, the LMF entity may perform at least one of the following: transmitting a determined SRS FH configuration to a serving BS of the UE or receiving an SRS FH configuration from the serving BS based on a first condition being fulfilled; or transmitting a determined PRS FH configuration to the UE based on a second condition being fulfilled. The SRS FH configuration transmitted to the serving BS may be determined by the LMF entity, and the SRS FH configuration received from the serving BS may be determined by the serving BS.

In some embodiments, the first condition may comprise: the UE being identified as a UE with a limited capability (e.g., as described in sub-solution 1-1 or 1-2), or there being an identified need for the SRS FH configuration (e.g., as described in sub-solution 1-3 or 1-4); and the second condition may comprise: the UE being identified as a UE with a limited capability (e.g., as described in sub-solution 1-1 or 1-2), or there being an identified need for the PRS FH configuration (e.g., as described in sub-solution 1-3 or 1-4).

In some embodiments, the PRS FH configuration is determined by the LMF entity based on one or more PRS configurations or one or more PRS FH configurations received from one or more BSs (e.g., as described in sub-solution 1-2); or the transmitted SRS FH configuration is determined by the LMF entity based on one or more SRS configurations or one or more SRS FH configurations received from one or more BSs (e.g., as described in sub-solution 1-2). The one or more BSs may include the serving BS and/or one or more neighbor BSs.

In some embodiments, the capability information of the UE is received from the serving BS or from the UE.

In some embodiments, the PRS FH configuration is determined by the serving BS, and the LMF entity may further receive the PRS FH configuration from the serving BS (e.g., as described in sub-solution 1-1).

In some embodiments, the PRS FH configuration is determined by the LMF entity and is transmitted to the UE in updated assistance data in the case that the LMF entity identifies the need for the PRS FH configuration (e.g., as described in sub-solution 1-3), wherein the LMF entity may identify the need for the PRS FH configuration when an accuracy requirement for positioning is increased to a first threshold, or when a received PRS measurement result does not satisfy the accuracy requirement.

In some embodiments, the LMF entity may further receive, from the UE, a request for PRS FH configuration (e.g., as described in sub-solution 1-4).

In some embodiments, in the case that the LMF entity identifies the need for the SRS FH configuration, the LMF entity may further determine the transmitted SRS FH configuration, or transmit a request for SRS FH configuration to the serving BS (e.g., as described in sub-solution 1-3), wherein the LMF entity may identify the need for the SRS FH configuration when an accuracy requirement for positioning is increased to a first threshold, or when a received SRS measurement result does not satisfy the accuracy requirement.

In some embodiments, the LMF entity may further transmit, to the serving BS, a request for the PRS FH configuration or the SRS FH configuration (e.g., as described in sub-solution 1-1).

In some embodiments, the request may indicate a type of the PRS FH configuration or the SRS FH configuration, for example, a configuration for any of the two types of PRS FH as shown in FIGS. 2A and 2B or the two types of SRS FH as shown in FIGS. 3A and 3B.

In some embodiments, the LMF entity may further transmit, to the serving BS, a first indication indicating an activation or deactivation associated with the SRS FH configuration, or transmit, to the UE, a second indication indicating an activation or deactivation associated with the PRS FH configuration (e.g., as described in sub-solution 1-5).

In some embodiments, the first indication is associated with first time information to activate or deactivate the SRS FH configuration, or the second indication is associated with second time information to activate or deactivate the PRS FH configuration.

In some embodiments, the LMF entity may further transmit, to a neighbor BS of the serving BS, the first indication or the second indication.

In some embodiments, the LMF entity may further receive, from the serving BS, a configuration of a measurement gap or a PPW for performing location measurements, and determine the PRS FH configuration based at least in part on the configuration of the measurement gap or the PPW (e.g., as described in sub-solution 2-1).

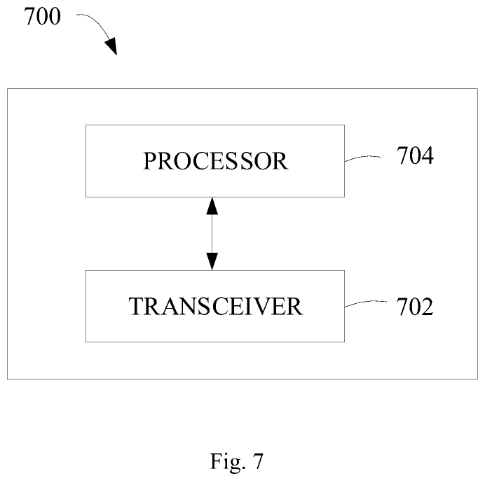

FIG. 7 illustrates a simplified block diagram of an apparatus 700 according to some embodiments of the present disclosure.

As shown in FIG. 7, an example of the apparatus 700 may include at least one processor 704 and at least one transceiver 702 coupled to the processor 704. The apparatus 700 may be a UE, a BS, an LMF entity, or any other device with similar functions.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of a UE as described with respect to any of FIGS. 1-6. For example, the processor 704 may be configured to: receive, via the transceiver 702, an SRS FH configuration or a PRS FH configuration based on a condition being fulfilled; and perform an SRS transmission based on the SRS FH configuration in the case that the SRS FH configuration is received, or perform a PRS measurement based on the PRS FH configuration in the case that the PRS FH configuration is received.

In some embodiments of the present disclosure, the apparatus 700 may be a BS. The transceiver 702 and the processor 704 may interact with each other so as to perform the operations of a BS as described with respect to any of FIGS. 1-6. For example, the processor 704 may be configured to: receive, via the transceiver 702, capability information of a UE; and perform at least one of the following: transmitting, via the transceiver 702, an SRS FH configuration to the UE based on a first condition being fulfilled; or transmitting, via the transceiver 702, a PRS FH configuration to an LMF entity or receiving, via the transceiver 702, a determined PRS FH configuration from the LMF entity based on a second condition being fulfilled.

In some embodiments of the present disclosure, the apparatus 700 may be an LMF entity. The transceiver 702 and the processor 704 may interact with each other so as to perform the operations of an LMF entity as described with respect to any of FIGS. 1-6. For example, the processor 704 may be configured to: receive, via the transceiver 702, capability information of a UE; and perform at least one of the following: transmitting, via the transceiver 702, a determined SRS FH configuration to a serving BS of the UE or receiving, via the transceiver 702, an SRS FH configuration from the serving BS based on a first condition being fulfilled; or transmitting, via the transceiver 702, a determined PRS FH configuration to the UE based on a second condition being fulfilled.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement any method as described above. For example, the computer-executable instructions, when executed, may cause the processor 704 to interact with the transceiver 702 to perform the operations of any method as described with respect to FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a sounding reference signal (SRS) frequency hopping (FH) configuration or a positioning reference signal (PRS) FH configuration based on a condition being fulfilled; and
perform an SRS transmission based on the SRS FH configuration in response to the SRS FH configuration being received, or perform a PRS measurement based on the PRS FH configuration in response to the PRS FH configuration being received.

2. The UE of claim 1, wherein the condition comprises one or more of the UE being identified as a UE with a limited capability, or an identified need for the SRS FH configuration or the PRS FH configuration.

3. The UE of claim 2, wherein the at least one processor is configured to cause the UE to transmit a request for PRS FH configuration in response to the UE identifying a need for the PRS FH configuration, and wherein the UE identifies the need for the PRS FH configuration in response to an accuracy requirement for positioning satisfying a first threshold or in response to a reference signal received power (RSRP) value of a measured PRS satisfying a second threshold during a time duration.

4. The UE of claim 2, wherein the at least one processor is configured to cause the UE to receive the SRS FH configuration or the PRS FH configuration in response to a location management function (LMF) entity identifying a need for the SRS FH configuration or for the PRS FH configuration, wherein the LMF entity identifies the need for the SRS FH configuration or for the PRS FH configuration in response to an accuracy requirement for positioning satisfying a first threshold or in response to a SRS or PRS measurement result not satisfying the accuracy requirement.

5. The UE of claim 1, wherein the at least one processor is further configured to cause the UE to receive via the transceiver a first indication indicating an activation or deactivation associated with the SRS FH configuration or a second indication indicating an activation or deactivation associated with the PRS FH configuration.

6. The UE of claim 1, wherein the at least one processor is configured to cause the UE to transmit a request for activating or deactivating the SRS FH configuration or for activating or deactivating the PRS FH configuration.

7. A base station (BS), comprising:
at least one memory; and
at least one processor coupled with the at least one memory and configured to cause the BS to:
receive capability information of a user equipment (UE); and
perform at least one of:
transmitting a sounding reference signal (SRS) frequency hopping (FH) configuration to the UE in response to a first condition being fulfilled; or
transmitting a positioning reference signal (PRS) FH configuration to a location management function (LMF) entity or receiving a determined PRS FH configuration from the LMF entity in response to a second condition being fulfilled.

8. The BS of claim 7, wherein:
the first condition comprises one or more of the UE being identified as a UE with a limited capability or there being an identified need for the SRS FH configuration; and
the second condition comprises one or more of the UE being identified as a UE with a limited capability or there being an identified need for the PRS FH configuration.

9. The BS of claim 7, wherein the at least one processor is configured to cause the BS to receive a request for the PRS FH configuration or the SRS FH configuration.

10. The BS of claim 7, wherein in response to the SRS FH configuration being determined by the BS, the at least one processor is configured to cause the BS to transmit the SRS FH configuration to the LMF entity.

11. The BS of claim 7, wherein the at least one processor is configured to cause the BS to:
receive a first indication indicating an activation or deactivation associated with the SRS FH configuration; and
transmit the first indication to the UE.

12. The BS of claim 7, wherein the at least one processor is configured to cause the BS to:
transmit a configuration of a measurement gap or a PRS processing window (PPW) for performing location measurements, wherein the configuration is determined based at least in part on the PRS FH configuration; or
transmit the configuration of the measurement gap or the PPW for performing location measurements.

13. A network equipment (NE) comprising a location management function (LMF) entity, comprising:
at least one memory; and
at least one processor coupled with the at least one memory and configured to cause the NE to:
receive capability information of a user equipment (UE); and
perform at least one of:
transmitting a sounding reference signal (SRS) frequency hopping (FH) configuration to a serving base station (BS) of the UE or receiving an SRS FH configuration from the serving BS in response to a first condition being fulfilled; or
transmitting a positioning reference signal (PRS) FH configuration to the UE in response to a second condition being fulfilled.

14. The LMF entity NE of claim 13, wherein the at least one processor is configured to cause the NE to determine the PRS FH configuration by the LMF entity and transmit the PRS FH configuration to the UE as part of updated assistance data in response to the LMF entity identifying a need for the PRS FH configuration, and wherein the LMF entity identifies the need for the PRS FH configuration in response to an accuracy requirement for positioning satisfying a first threshold or in response to a PRS measurement result not satisfying the accuracy requirement.

15. The NE of claim 13, wherein in response to the LMF entity identifying a need for the SRS FH configuration, the at least one processor is configured to cause the NE to:
determine the SRS FH configuration; or
transmit a request for SRS FH configuration to the serving BS,
wherein the LMF entity identifies the need for the SRS FH configuration in response to an accuracy requirement for positioning satisfying a first threshold or in response to an SRS measurement result not satisfying the accuracy requirement.

16. A method performed by a user equipment (UE), comprising:
receiving a sounding reference signal (SRS) frequency hopping (FH) configuration or a positioning reference signal (PRS) FH configuration based on a condition being fulfilled; and
performing an SRS transmission based on the SRS FH configuration in response to the SRS FH configuration being received, or perform a PRS measurement based on the PRS FH configuration in response to the PRS FH configuration being received.

17. The method of claim 16, wherein the condition comprises one or more of the UE being identified as a UE with a limited capability, or an identified need for the SRS FH configuration or the PRS FH configuration.

18. The method of claim 16, further comprising transmitting a request for PRS FH configuration in response to the UE identifying a need for the PRS FH configuration, and wherein the UE identifies the need for the PRS FH configuration in response to an accuracy requirement for positioning satisfying a first threshold or in response to a reference signal received power (RSRP) value of a measured PRS satisfying a second threshold during a time duration.

19. The method of claim 16, further comprising receiving the SRS FH configuration or the PRS FH configuration in response to a location management function (LMF) entity identifying a need for the SRS FH configuration or for the PRS FH configuration, wherein the LMF entity identifies the need for the SRS FH configuration or for the PRS FH configuration in response to an accuracy requirement for positioning satisfying a first threshold or in response to a SRS or PRS measurement result not satisfying the accuracy requirement.

20. The method of claim 16, further comprising receiving a first indication indicating an activation or deactivation associated with the SRS FH configuration or a second indication indicating an activation or deactivation associated with the PRS FH configuration.
